(19) United States
(12) Patent Application Publication
(10) Pub. No.: US 2011/0099404 A1
(43) Pub. Date: Apr. 28, 2011

(54) ELECTRONIC DEVICE, METHOD OF CONTROLLING AN ELECTRONIC DEVICE, AND SYSTEM-ON-CHIP

(75) Inventors: Herman Hartmann, Veldhoven (NL); Artur Tadeusz Burchard, Eindhoven (NL)

(73) Assignee: NXP B.V., Eindhoven (NL)

(21) Appl. No.: 13/001,261

(22) PCT Filed: Jun. 23, 2009
(86) PCT No.: PCT/IB09/52692

§ 371 Date: Dec. 23, 2010

(30) Foreign Application Priority Data
Jun. 25, 2008 (EP) 08158926.9

(51) Int. Cl. G06F 1/32

(52) U.S. Cl. 713/323

(57) ABSTRACT

An electronic device is provided which comprises at least one processing unit (CPU) for processing at least one application having at least one task at least one operating frequency, an user event detecting unit (UED) for detecting at least one user event which initiates at least one task with an associated user event execution time, and a power manager (PM) for managing a power consumption of the processing unit (CPU) by controlling the operating frequency of the processing unit (CPU) in dependence of the associated user event execution time.

### FIELD OF THE INVENTION

The present invention relates to an electronic device, to a method of controlling an electronic device, and a system-on-chip.

### BACKGROUND OF THE INVENTION

In modern mobile or portable devices power management has become a major issue as typically the energy sources of the mobile or portable devices have a limited capacity while the functionality of modern mobile and portable devices have increased significantly. One aspect of power management is the so-called dynamic power management DPM. By means of a dynamic power management DPM an efficient power management over a variability of applications can be provided. Furthermore, less heat is generated which means improved thermal properties and related benefits, i.e. the device can be operated fan-less. Through the dynamic power management the power delivered to an electronic device or an integrated circuit can be adapted to the actual workload of an application, which may vary very greatly. A specific application which is executed on a hardware unit requires a certain level of workload for a certain period of time. The workload can be measured as a ratio of the execution time and the total time available to the hardware unit. The workload can also be measured as a ratio of the number of clock cycles used for the execution of the application and the total number of available clock cycles for a period. By means of a frequency and/or voltage scaling the power consumption of a hardware unit is controlled.

One feature of a good power management should be that any real-time applications should not be effected by the power management, i.e. real-time applications should not be affected in sense of missing any of its deadlines. In general the execution of real-time application can be affected as long as all deadlines are met. In particular, power managing by changing frequency always changes the timing of a real-time application. An end of execution of each task may come closer to its deadline, but it should not miss the deadline. The power management can for example be performed by changing the frequency and the voltage of parts of the electronic device or the integrated circuit.

Typical applications which are performed on the electronic device may include best-effort tasks or real-time tasks. A best-effort task relates to a task that is not constrained to a deadline but is executed as fast as possible. Best-effort task may include internet browsing, file browsing, and file manipulation (copying, moving etc.) as well as office applications. For portable systems best-effort task may include picture taking and picture browsing.

A further example of a best-effort task is a response of the electronic device to a user event. Typically, best-effort tasks are processed by starting the application and changing the clock frequency to its maximum and keep the maximum clock frequency during the start-up of a task. User events of an electronic device may include browsing pictures, making pictures for example by means of mobile phones or digital cameras, entering a digit or letter in a SMS message or document, pausing the rendering, playing a next song, browsing through a play list for example of a media player like a MP3 player, starting up an application and entering or exiting a new menu.

A real-time task relates to a task that has deadlines, i.e. it has to be executed before a certain deadline. Here is not important whether the task is executed fast or slow as long as the deadline is met. Examples for such task may include video and audio playback.

### SUMMARY OF THE INVENTION

It is therefore an object of the invention to provide an electronic device with an improved power efficiency.

This object is solved by an electronic device according to claim 1, a method for controlling an electronic device according to claim 6, and a system-on-chip according to claim 7.

Therefore, an electronic device is provided which comprises at least one processing unit for processing at least one application having at least one task at least one operating frequency, an user event detecting unit for detecting at least one user event which initiates at least one task with an associated user event execution time, and a power manager for managing a power consumption of the processing unit by controlling the operating frequency of the processing unit in dependence of the associated user event execution time.

According to an aspect of the invention the power manager is adapted to reduce the operating frequency of the at least one processing unit such that the processing of the at least one user event initiated task is performed while substantially utilizing the associated user event execution time.

According to an aspect of the invention a task list unit for storing a task ID and an associated execution time which is required to execute the task.

According to an aspect of the invention the user event execution time corresponds to 100 to 200 ms, more particular 150 ms.

According to a further aspect of the invention the electronic device comprises a voltage setting unit, coupled to the power manager, for setting an operating voltage of the processing unit based on the controlled operating frequency; and a clock generation unit for setting a clock frequency of the processing unit based on the controlled operating frequency.

The invention also relates to a method of controlling an electronic device having at least one processing unit for processing at least one application having at least one task at least one operating frequency. At least one user event is detected which initiates at least one task with an associated user event execution time. A power consumption of the processing unit is managed by controlling the operating frequency of the processing unit in dependence of the associated user event execution time.

The invention also relates to a system-on-chip which comprises at least one processing unit for processing at least one application having at least one task at least one operating frequency, an user event detecting unit for detecting at least one user event which initiates at least one task with an associated user event execution time, and a power manager for managing a power consumption of the processing unit by controlling the operating frequency of the processing unit in dependence of the associated user event execution time.

The invention relates to the realization that a perception threshold for changes e.g. in graphical user interfaces caused by user events is in the range of 150 to 200 ms. Therefore, any application which is performed by an electronic device should respond to a user event within 150 to 200 ms in order to appear instantaneous. Hence, any task which needs to be executed as response to the user events and which needs to generate a change e.g. in the graphical user interface should be executed within a time frame of 150 to 200 ms, i.e. they do not necessarily need to be executed faster than that. This realization is used according to the present invention to reduce the power consumption of an electronic device. If it is clear that the result of the processing of a task only needs to be available after 150 to 200 ms, then the processing of the task can be controlled accordingly in order to reduce the power consumption while still meeting the deadlines. In particular, a dynamic power management is applied to the electronic device to adapt the clock frequency of the processor to the actual workload. If a task is executed faster than the required time limit, according to the invention the executing time may be increased for example by reducing the maximum clock frequency. This can be performed to achieve that the actual time of execution substantially corresponds to the above-mentioned time limit. This is advantageous as the energy consumption is reduced without any noticeable changes to the user. It should be noted that the principle of the invention may not only be applied to user events with respect to changes in the graphical user interface but also to other changes to a user event as long as a delay in changes is not noticeable by the user.

Further aspects of the invention are defined in the dependent claims.

### BRIEF DESCRIPTION OF THE DRAWINGS

Embodiments and advantages of the invention will now be described in more detail with reference to the Figures.

FIG. 1 shows a basic representation of a workload shape,

FIG. 2 shows a further basic representation of a workload shape,

FIG. 3 shows still a further basic representation of a workload shape according to a first embodiment,

FIG. 4 shows a basic representation of a workload shape according to a second embodiment,

FIG. 5 shows still a further basic representation of a workload shape,

FIG. 6 shows a basic representation of a workload shape, and

FIG. 7 shows a basic block diagram of an electronic device according to the invention.

### DETAILED DESCRIPTION OF EMBODIMENTS

According to some embodiments of the invention the power management of a mobile electronic device is controlled by means of a dynamic power management DPM, wherein a dynamic voltage and frequency scaling DVFS is performed. The embodiments of the invention are further related to the realization that a perception threshold for changes in graphical user interfaces caused by user events (which may initiate or be associated to best-effort traffic) is in the range of 150 to 200 ms.

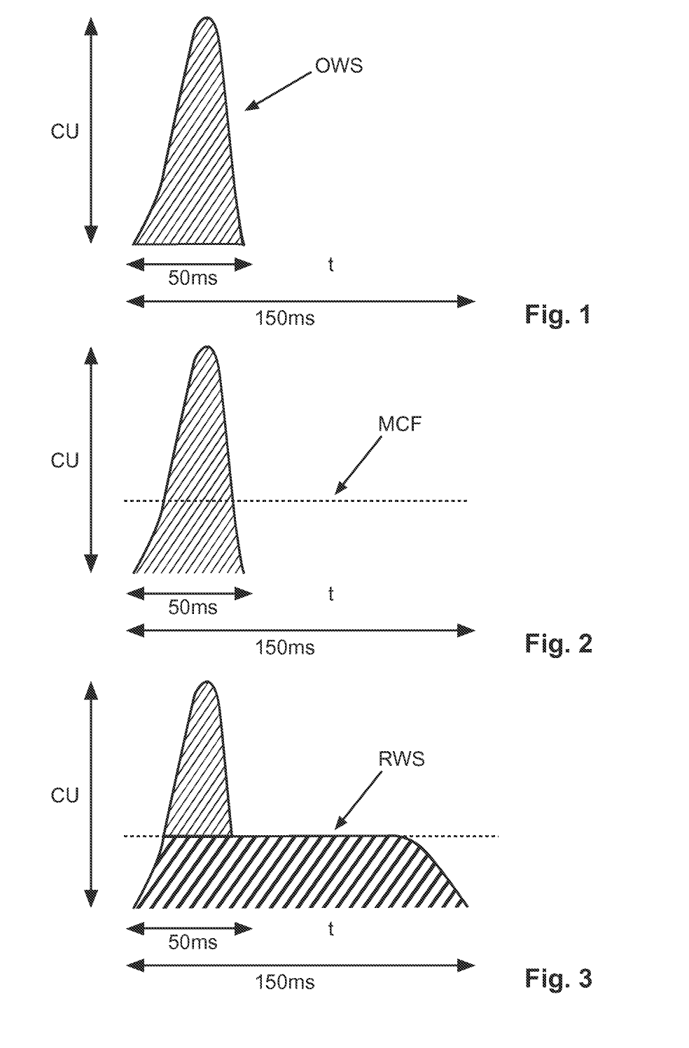

FIG. 1 shows a basic representation of a workload shape. This workload shape corresponds to a workload of a task in response to a user event. In FIG. 1, the usage of a processor CPU CU is depicted over time t. The task is performed within 50 ms and leads to the depicted original workload shape OWS. It should be noted that the task is already finished after 50 ms while 150 ms are available to avoid that the user has an impression of a non-instantaneous response. Accordingly, the maximum clock frequency can be reduced while the deadline of 150 ms is still met.

FIG. 2 shows a basic representation of the workload shape of FIG. 1. The basic representation of FIG. 2 corresponds to the basic representation of FIG. 1 with an additional dotted line MCF which corresponds to the maximum clock frequency as adjusted by a dynamic power management according to the invention.

FIG. 3 shows a basic representation of a workload shape according to a first embodiment. In FIG. 3, the clock frequency of the electronic device or parts thereof is restricted to the maximum clock frequency MCF such that the workload is changed as depicted in FIG. 3. In other words, the clock frequency of the processor CPU will not be higher than the maximum clock frequency. This has the effect that the processor CPU will required more time to process the required task.

Here, the maximum clock frequency MCF can be reduced to only one third. This can be performed as a linear relationship between the maximum frequency and the execution time is present. In particular, the maximum clock frequency can be reduced until the size of the surface of the original workload shape OWS matches the size of the surface beneath the line set by the maximum clock frequency MCF. In other words, the integral of the resulting workload shape should match the integral of the original workload shape OWS. It should be noted that the maximum clock frequency will only then be used for the entire execution period if a square-shaped workload is present.

It should be noted that by implementing the first embodiment of the invention, the power consumption will be substantially lower than in the case as shown according to FIG. 1. This can be performed as a scaling of the operating frequency will also enable a scaling of the supplied voltage. Due to the fact that the power consumption is a function of the squared supply voltage to the integrated circuit, the power consumption according to the first embodiment can be reduced even for a square-shaped workload. In the case shown in FIG. 3, the reduction of the consumed power can be 34% (0, 7²/1,2²=0, 34).

If T corresponds to the time which is required to execute a set of task in response to a user event and if T is smaller than 150 ms, then the maximum required clock frequency can be reduced to T/150 ms with respect to the original clock frequency.

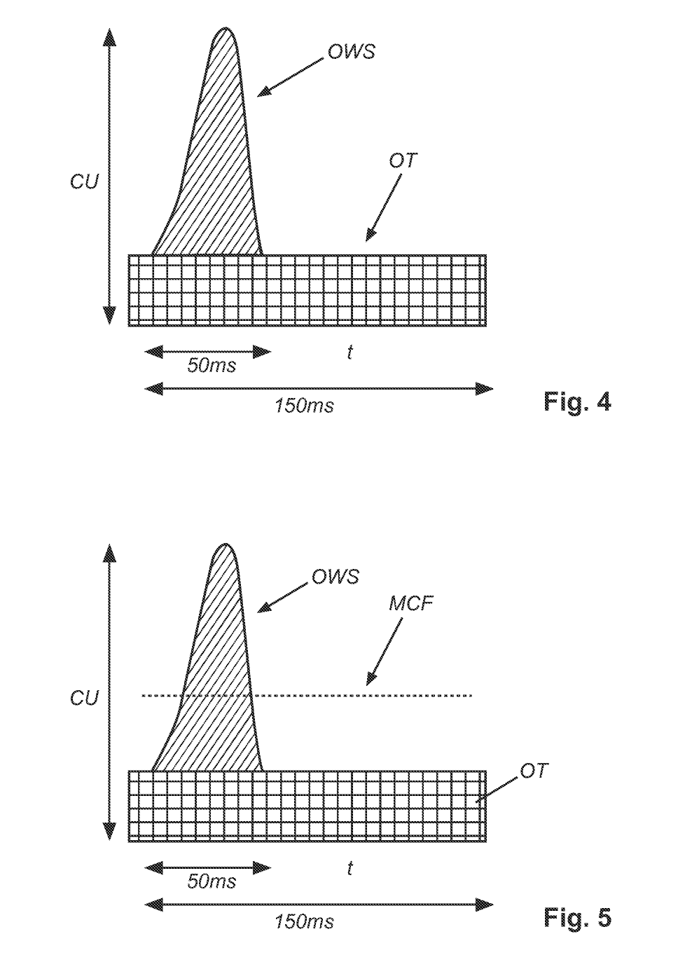

FIG. 4 shows a basic representation of a workload shape according to a second embodiment. In addition to the original workload shape OWS; also further tasks OT are processed by a processor in the electronic device. It should be noted that the principles of the invention can also be applied to such a situation where not only the original workload shape OWS but also other tasks need to be processed. These additional tasks OT may for example relate to audio and/or video processing. As the processing of the original workload shape OWS without restricting the maximum clock frequency is ended after 50 ms, the principles of the invention can also be applied to such a situation.

FIG. 5 shows a basic representation of the workload shape of FIG. 4. The basic representation of FIG. 5 corresponds to the basic representation of FIG. 4 with an additional dotted line MCF which corresponds to the maximum clock frequency as adjusted by a dynamic power management according to the invention.

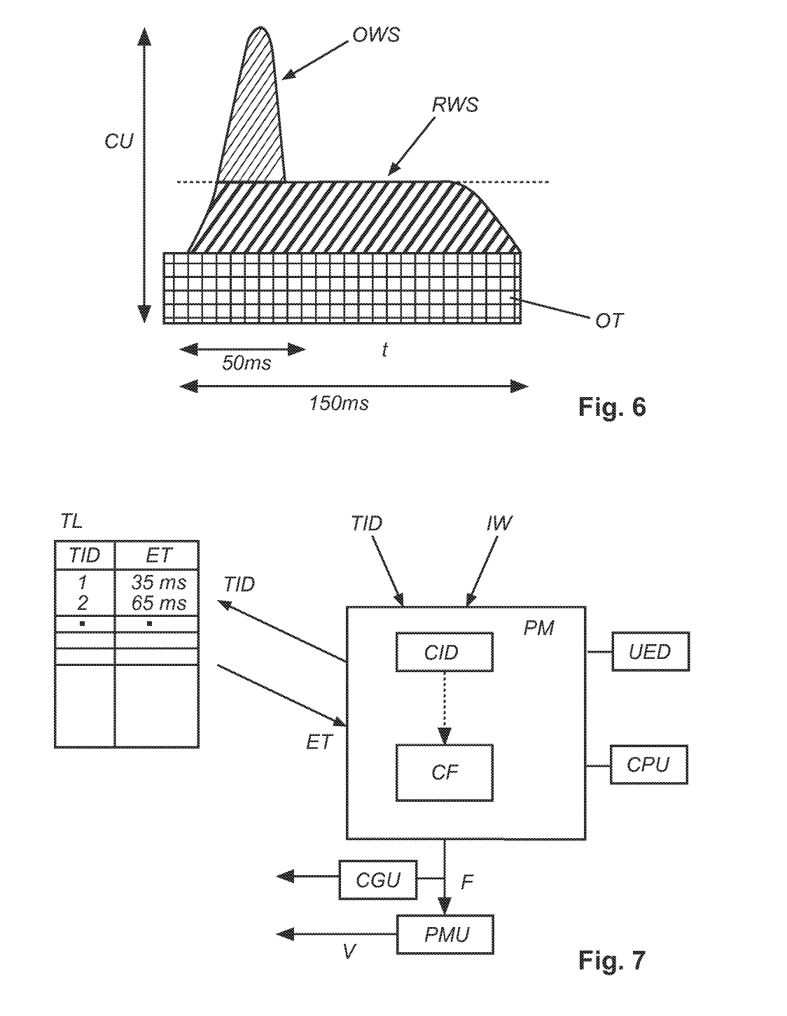

FIG. 6 shows a basic representation of a workload shape according to a third embodiment. In FIG. 6, the maximum clock frequency of the processor in the electronic device is reduced such that a resulting workload shape RWS is achieved. Accordingly, the workload shape according to FIG. 6 corresponds to the workload shape according to FIG. 4 with the addition of the further task OT which needs to be processed. During the calculation of the maximum clock frequency, the additional task OT needs to be taken under consideration. This can for example be performed by a best guess approach.

FIG. 7 shows a block diagram of an electronic device according to a fourth embodiment. The electronic device comprises a task list TL, a power manager PM as well as a power management unit PMU and a clock generation unit CGU. The power manager PM, can be implemented by software, and will receive information from an operating system with respect to the initial workload IW. The power manager PM furthermore receives information with respect to the tasks like the task ID TID. In the task list TD, the execution time ET for each task is stored. Based on this information, the power manager PM determines whether the clock frequency can be reduced. Preferably, it also determines the possible reduction of the clock frequency. The power management unit PMU and the clock generation unit CGU can be implemented as hardware units. The power management unit PMU can be implemented as a voltage setting unit e.g. as a voltage converter that sets the voltage based on the frequency that was determined by the power manager PM. The clock generation unit CGU sets the clock frequency based on the frequency that was determined by the power manager PM.

The task list may also comprise information with respect to further tasks OT which need to be processed by the processor in the electronic device. As mentioned above, the reduction of the clock frequency will also allow the processor in the electronic device to operate at lower voltages.

The present invention relates to the idea to perform a task (which can be best effort traffic) not as fast as possible but to perform it in the required time limits, thereby reducing the power consumption. Such a task can be a best-effort task as a response of the electronic device to a user event. User events of an (mobile) electronic device may include browsing pictures, making pictures for example by means of mobile phones or digital cameras, entering a digit or letter in a SMS message or document, pausing the rendering, playing a next song, browsing through a play list for example of a media player like a MP3 player, starting up an application and entering or exiting a new menu.

The principles of the invention can be applied to e.g. a system on chip with a central processing unit CPU. Such a system on chip can be used in any portable or mobile devices like MP3 players, mobile phones, laptops, PDA, mobile DVD players and multi-media systems. However, it should be noted that the principles of the invention does not necessarily have to be implemented by a system on chip. The principles of the invention can also be applied for any system in which a CPU is used, such as an Intel or AMD chip. Also in this case the power consumption can be reduced with this invention.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be constrained as limiting the scope of the claims.

1. Electronic device, comprising:
at least one processing unit for processing at least one application having at least one task with at least one operating frequency,
a user event detecting unit for detecting at least one user event which initiates at least one task with an associated user event execution time, and
a power manager for managing a power consumption of the processing unit by controlling the operating frequency of the processing unit in dependence of the associated user event execution time.

2. Electronic device according to claim 1, wherein the power manager is adapted to reduce the operating frequency of the at least one processing unit such that the processing of the at least one user event initiated task is performed while substantially utilizing the associated user event execution time.

3. Electronic device according to claim 1, further comprising:
a task list unit for storing a task ID and an associated execution time which is required to execute the task.

4. Electronic device according to claim 1, wherein the user event execution time corresponds to 100 to 200 ms.

5. Electronic device according to claim 1, further comprising:
a voltage setting unit, coupled to the power manager, for setting an operating voltage of the processing unit based on the controlled operating frequency; and
a clock generation unit for setting a clock frequency of the processing unit based on the controlled operating frequency.

6. Method of controlling an electronic device having at least one processing unit for processing at least one application having at least one task with at least one operating frequency, comprising the steps of:
detecting at least one user event which initiates at least one task with an associated user event execution time, and
managing a power consumption of the processing unit by controlling the operating frequency of the processing unit in dependence of the associated user event execution time.

7. System-on-chip, comprising:
at least one processing unit for processing at least one application having at least one task with at least one operating frequency,
an user event detecting unit for detecting at least one user event which initiates at least one task with an associated user event execution time, and
a power manager for managing a power consumption of the processing unit by controlling the operating frequency of the processing unit in dependence of the associated user event execution time.
